(19) United States
(12) Patent Application Publication
(10) Pub. No.: US 2013/0151293 A1
(43) Pub. Date: Jun. 13, 2013

(54) RESERVATION SYSTEM FOR ELECTRIC VEHICLE CHARGING STATIONS AND METHOD OF USING THE SAME

(71) Applicant: Electric Transportation Engineering Corporation, d/b/a ECOtality North America, Phoenix, AZ (US)

(72) Inventors: Donald B. Karner, Phoenix, AZ (US); Carmelo A. Carpinteri, Phoenix, AZ (US)

(73) Assignee: Electric Transportation Engineering Corporation, d/b/a ECOtality North America, Phoenix, AZ (US)

(21) Appl. No.: 13/722,855

(22) Filed: Dec. 20, 2012

Related U.S. Application Data
(63) Continuation of application No. PCT/US2011/034667, filed on Apr. 29, 2011.
Application No. PCT/US2011/034667 is a continuation of application No. PCT/US2011/037587, filed on May 23, 2011.
Application No. PCT/US2011/037587 is a continuation of application No. PCT/US2011/037588, filed on May 23, 2011.
Application No. PCT/US2011/037588 is a continuation of application No. PCT/US2011/037590, filed on May 23, 2011.
Application No. PCT/US2011/037590 is a continuation of application No. 13/713,834, filed on Dec. 13, 2012.
Application No. 13/713,834 is a continuation of application No. 13/713,855, filed on Dec. 13, 2012.
Application No. 13/713,855 is a continuation of application No. 13/713,876, filed on Dec. 13, 2012.
Application No. 13/713,834 is a continuation of application No. PCT/US2011/034667, filed on Apr. 29, 2011.
Application No. 13/713,855 is a continuation of application No. PCT/US2011/034667, filed on Apr. 29, 2011.
Application No. 13/713,876 is a continuation of application No. PCT/US2011/034667, filed on Apr. 29, 2011.
Application No. 13/713,834 is a continuation of application No. PCT/US2011/037587, filed on May 23, 2011.
Application No. 13/713,855 is a continuation of application No. PCT/US2011/037587, filed on May 23, 2011.
Application No. 13/713,876 is a continuation of application No. PCT/US2011/037587, filed on May 23, 2011.
Application No. 13/713,834 is a continuation of application No. PCT/US2011/037588, filed on May 23, 2011.
Application No. 13/713,855 is a continuation of application No. PCT/US2011/037588, filed on May 23, 2011.
Application No. 13/713,876 is a continuation of application No. PCT/US2011/037588, filed on May 23, 2011.
Application No. 13/713,834 is a continuation of application No. PCT/US2011/037590, filed on May 23, 2011.
Application No. 13/713,855 is a continuation of application No. PCT/US2011/037590, filed on May 23, 2011.
Application No. 13/713,876 is a continuation of application No. PCT/US2011/037590, filed on May 23, 2011.
Application No. PCT/US2011/037587 is a continuation of application No. PCT/US2011/034667, filed on Apr. 29, 2011.
Application No. PCT/US2011/037588 is a continuation of application No. PCT/US2011/034667, filed on Apr. 29, 2011.
Application No. PCT/US2011/037590 is a continuation of application No. PCT/US2011/034667, filed on Apr. 29, 2011.
(60) Provisional application No. 61/367,316, filed on Jul. 23, 2010.
(60) Provisional application No. 61/367,316, filed on Jul. 23, 2010.
(60) Provisional application No. 61/367,316, filed on Jul. 23, 2010.
(60) Provisional application No. 61/367,316, filed on Jul. 23, 2010.
(60) Provisional application No. 61/367,321, filed on Jul. 23, 2010.
(60) Provisional application No. 61/367,321, filed on Jul. 23, 2010.
(60) Provisional application No. 61/367,321, filed on Jul. 23, 2010.
(60) Provisional application No. 61/367,321, filed on Jul. 23, 2010.
(60) Provisional application No. 61/367,337, filed on Jul. 23, 2010.
(60) Provisional application No. 61/367,337, filed on Jul. 23, 2010.
(60) Provisional application No. 61/367,337, filed on Jul. 23, 2010.
(60) Provisional application No. 61/367,337, filed on Jul. 23, 2010.
(60) Provisional application No. 61/367,337, filed on Jul. 23, 2010.
(60) Provisional application No. 61/367,337, filed on Jul. 23, 2010.
(60) Provisional application No. 61/367,337, filed on Jul. 23, 2010.
(60) Provisional application No. 61/367,337, filed on Jul. 23, 2010.
(60) Provisional application No. 61/367,317, filed on Jul. 23, 2010.
(60) Provisional application No. 61/367,317, filed on Jul. 23, 2010.
(60) Provisional application No. 61/367,317, filed on Jul. 23, 2010.
(60) Provisional application No. 61/367,317, filed on Jul. 23, 2010.

(51) Int. Cl. G06Q 10/02

(52) U.S. Cl. CPC G06Q 10/02
USPC 705/5

(57) ABSTRACT

Some embodiments include a reservation system for electric vehicle charging station and method of using the same as disclosed herein. Other embodiments of related systems and methods are also disclosed.

### CROSS-REFERENCE TO RELATED APPLICATIONS

This application is a continuation of: (a) International Patent Application Serial No. PCT/US2011/034667, filed Apr. 29, 2011, (b) International Patent Application Serial No. PCT/US2011/037587, filed May 23, 2011, (c) International Patent Application Serial No. PCT/US2011/037588, filed May 23, 2011, (d) International Patent Application Serial No. PCT/US2011/037590, filed May 23, 2011, (e) U.S. patent application Ser. No. 13/713,834, filed Dec. 13, 2012, (f) U.S. patent application Ser. No. 13/713,855, filed Dec. 13, 2012, and (g) U.S. patent application Ser. No. 13/713,876, filed Dec. 13, 2012. Meanwhile, each of U.S. patent application Ser. No. 13/713,834, U.S. patent application Ser. No. 13/713,855, and U.S. patent application Ser. No. 13/713,876 is a continuation of International Patent Application Serial No. PCT/US2011/034667, International Patent Application Serial No. PCT/US2011/037587, International Patent Application Serial No. PCT/US2011/037588, and International Patent Application Serial No. PCT/US2011/037590.

Further, each of International Patent Application Serial No. PCT/US2011/034667, International Patent Application Serial No. PCT/US2011/037587, International Patent Application Serial No. PCT/US2011/037588, and International Patent Application Serial No. PCT/US2011/037590 claims the benefit of: (1) U.S. Provisional Application Ser. No. 61/367,316, filed Jul. 23, 2010; (2) U.S. Provisional Application Ser. No. 61/367,321, filed Jul. 23, 2010; (3) U.S. Provisional Application Ser. No. 61/367,337, filed Jul. 23, 2010; and (4) U.S. Provisional Application Ser. No. 61/367,317, filed Jul. 23, 2010. Also, each of International Patent Application Serial No. PCT/US2011/037587, International Patent Application Serial No. PCT/US2011/037588, and International Patent Application Serial No. PCT/US2011/037590 is a continuation of International Patent Application Serial No. PCT/US2011/034667.

The disclosures of U.S. Provisional Application Ser. No. 61/367,316; U.S. Provisional Application Ser. No. 61/367,321; U.S. Provisional Application Ser. No. 61/367,337; U.S. Provisional Application Ser. No. 61/367,317; International Patent Application Serial No. PCT/US2011/034667, International Patent Application Serial No. PCT/US2011/037587, International Patent Application Serial No. PCT/US2011/037588, International Patent Application Serial No. PCT/US2011/037590, U.S. patent application Ser. No. 13/713,834, U.S. patent application Ser. No. 13/713,855, and U.S. patent application Ser. No. 13/713,876 are incorporated herein by reference in their entirety.

### STATEMENT REGARDING FEDERALLY SPONSORED RESEARCH OR DEVELOPMENT

This invention was made with U.S. Government support under Contract No. DE-EE00002194 awarded by the Department of Energy. The Government has certain rights in this invention.

### FIELD OF THE INVENTION

This invention relates generally to reservation systems, and relates more particularly to reservation systems for electric vehicle charging stations and related methods.

### DESCRIPTION OF THE BACKGROUND

As the number of electric vehicles in service continues to proliferate, the availability of electric vehicle charging stations to reliably provide electricity to the electric vehicles takes on increasing importance. Like conventional petroleum-based fueling stations, current electric vehicle charging stations are available on a first come, first serve basis; however, contrary to fueling a vehicle with petroleum-based fuels, which may take only a few minutes, charging a rechargeable energy storage system of an electric vehicle can take several minutes or even a few hours. Moreover, the present number of electric vehicles greatly exceeds the existing number of electric vehicle charging stations. As a result, a first come, first serve basis of availability for electric vehicle charging stations is insufficient to meet the demands for charging electric vehicles.

Accordingly, a need exists for a system and/or method that permits clients to reserve electric vehicle charging stations for their electric vehicles.

### BRIEF DESCRIPTION OF THE DRAWINGS

To facilitate further description of the embodiments, the following drawings are provided in which:

FIG. 1 illustrates an exemplary system for coordinating a request for a reservation of time during which to charge electric vehicles at vehicle charging stations, according to an embodiment;

FIG. 2 illustrates a computer system that is suitable for implementing an embodiment of the system of FIG. 1;

FIG. 3 illustrates a representative block diagram of an example of the elements included in the circuit boards inside chassis of the computer system of FIG. 2;

FIG. 4 illustrates a flow chart for an exemplary method for coordinating a reservation for a vehicle charging station via communications between a client computer system of a client and a charger computer system, according to an embodiment;

FIG. 5 illustrates an exemplary procedure of receiving the request for the reservation for the vehicle charging system, according to the embodiment of FIG. 4;

FIG. 6 illustrates an exemplary procedure of providing the first timeframe for the reservation, according to the embodiment of FIG. 4;

FIG. 7 illustrates an exemplary procedure of disabling the electrical connector of the vehicle charging station for at least a first part of the first timeframe, according to the embodiment of FIG. 4;

FIG. 8 illustrates a flow chart for an exemplary method for operating a vehicle charging station, according to an embodiment; and

FIG. 9 illustrates an exemplary procedure of authenticating the identity of the client of the vehicle charging station, according to the embodiment of FIG. 8.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled together, but not be mechanically or otherwise coupled together; two or more mechanical elements may be mechanically coupled together, but not be electrically or otherwise coupled together; two or more electrical elements may be mechanically coupled together, but not be electrically or otherwise coupled together. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

The term “real time” is defined with respect to operations carried out as soon as practically possible upon occurrence of a triggering event. A triggering event can comprise receipt of data necessary to execute a task or to otherwise process information. Because of delays inherent in transmission and/or in computing speeds, the term “real time” encompasses operations that occur in “near” real time or somewhat delayed from a triggering event.

### DETAILED DESCRIPTION OF EXAMPLES OF EMBODIMENTS

Some embodiments include a method for coordinating a reservation for an electric vehicle charging station. The method can be implemented via execution of computer instructions configured to run at one or more processing modules of a charger computer system and/or a centralized computer system and configured to be stored at one or more non-transitory memory storage modules of the charger computer system and/or the centralized computer system. The method can comprise: executing one or more first computer instructions configured to receive from a client computer system of a client a request for a reservation for the electric vehicle charging station; executing one or more second computer instructions configured to define a first timeframe for the reservation based on the request; and if the electric vehicle charging station is available for use to charge a rechargeable energy storage system of an electric vehicle of the client for the first timeframe, executing one or more third computer instructions configured to prevent the electric vehicle charging station from making available electricity for at least a first part of the first timeframe until receiving an authentication of the client.

Further embodiments include a method for coordinating a reservation for an electric vehicle charging station. The method can be implemented via execution of computer instructions configured to run at one or more processing modules of a client computer system of a client and configured to be stored at one or more non-transitory memory storage modules of the client computer system. The method can comprise: executing one or more first computer instructions configured to provide to a charger computer system and/or a centralized computer system a request for a reservation for the electric vehicle charging station; and executing one or more second computer instructions configured to receive a confirmation regarding whether or not the request for the reservation is approved.

Various embodiments include a system for coordinating a reservation for an electric vehicle charging station. The system comprises a charger computer system and/or a centralized computer system. The charger computer system and/or the centralized computer system can be configured to communicate with a client computer system of the client. Further, the charger computer system and/or the centralized computer system can be configured to receive from the client computer system a request for a reservation for the electric vehicle charging station and to define a first timeframe for the reservation based on the request. Meanwhile, the charger computer system and/or the centralized computer system can be configured such that if the electric vehicle charging station is available for use to charge a rechargeable energy storage system of an electric vehicle for the first timeframe, the charger computer system and/or the centralized computer system prevents the electric vehicle charging station from making available electricity for at least a first part of the first timeframe until an authentication of the client is received.

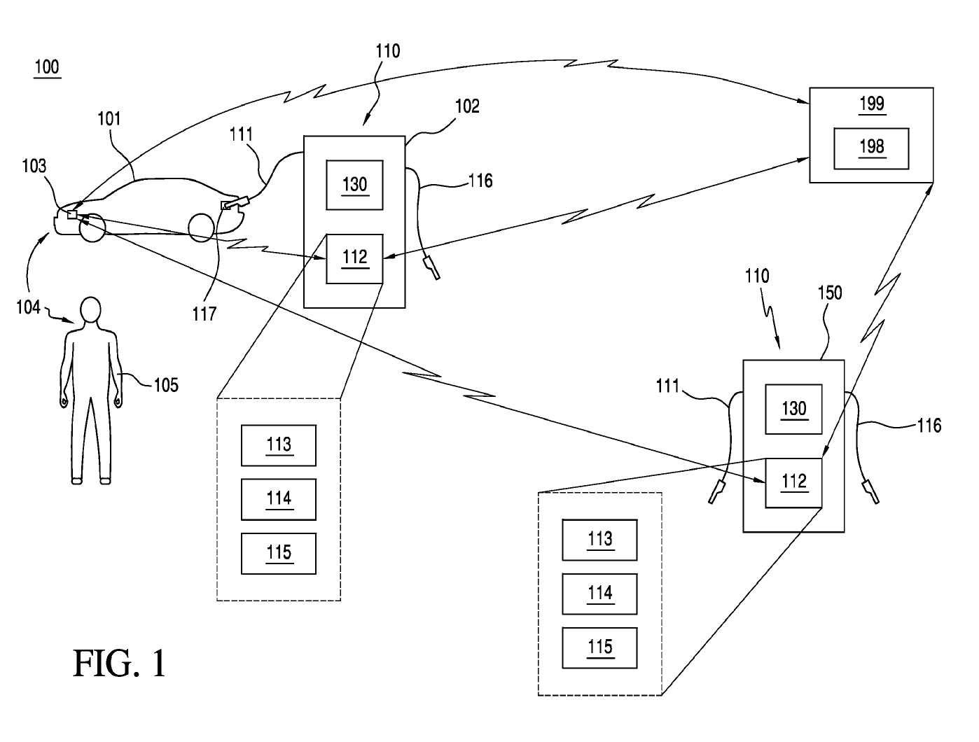

Turning to the drawings, FIG. 1 illustrates system 100 for coordinating a request for a reservation of time during which to charge electric vehicle 101 at vehicle charging station 102, according to a first embodiment of system 100. System 100 is merely exemplary and is not limited to the embodiments presented herein. System 100 can be employed in many different embodiments or examples not specifically depicted or described herein. In some embodiments, all or part of system 100 can be configured to operate in real time.

In many embodiments, the request for the reservation of time can be requested by client computer system 103 of client 104. In some embodiments, the request for the reservation of time can be requested by client computer system 103 automatically based on one or more parameters similar to some or all of the reservation data, as described below (e.g., when the energy level of rechargeable energy storage system 117, as described below, of electric vehicle 101 reaches a particular or predetermined level). In the same or different embodiments, client 104 can be electric vehicle 101 and/or user 105. In other embodiments, the request for the reservation of time can be requested directly by user 105, instead of via client computer system 103, as described in greater detail below. In many embodiments, electric vehicle 101 can comprise one of a car, a truck, a motorcycle, a bicycle, a scooter, a boat, a train, an aircraft, an airport ground support equipment, a material handling equipment (e.g., a fork-lift), etc. In the same or different embodiments, electric vehicle 101 can comprise one of a full electric vehicle or any other grid-connected vehicle. In some embodiments, user 105 can comprise a person desiring to use vehicle charging station 102 and/or one or more other vehicle charging stations of one or more vehicle charging stations 110, as described below. In the same or different embodiments, user 105 can comprise at least one of the owner, operator, or passenger of electric vehicle 101.

There can be many different options for requesting the reservation of time, whether by client computer system 103 or by user interface 130, as described below. In various embodiments, client computer system 103 and/or charger computer system 112 can generate the request for the reservation time based on a needs basis (e.g., an amount/length of charge) provided by user 105, but in other embodiments, user 105 can select specific reservations of time based on various search factors. Search factors can comprise a geographic region, a proximity of the one or more vehicle charging stations 110 to the location of a specific or a category of business, entertainment venue, etc., a history of use of user 105, as described below, and/or any of various favorite charge times/dates and/or vehicle charging stations of the one or more vehicle charging stations 110, etc.). In some examples, client computer system 103 and/or any charger computer system 112 can be configured to provide user 105 with a graphical user interface (GUI) displaying a map showing the locations of at least one vehicle charging station of the one or more vehicle charging stations 110 from which user 105 can choose to make a reservation at the at least one vehicle charging station of the one or more vehicle charging stations 110.

In various embodiments, user interface 130 and/or client computer system 103 can be configured to indicate (e.g., via a display, such as a touch screen display, of user interface 130 and/or client computer system 103) the time of completion of a current reservation of a particular electric vehicle charging station of electric vehicle charging station(s) 110 (e.g., an electric vehicle charging station with which user 105 is interacting) and/or an impending start time of a reservation (e.g., where a reservation is present and set to begin within a particular amount of time such as 30 minutes, an hour, two hours, etc.) or the particular electric vehicle charging station. The time of completion and/or the impending start time can be clearly indicated to user 105 when user 105 is attempting to make a reservation at and/or of the particular electric vehicle charging station.

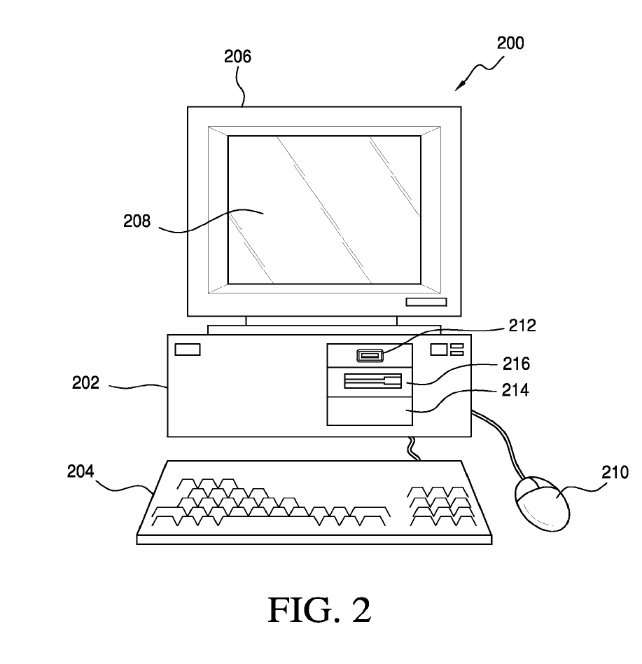

As illustrated in FIG. 1, in some embodiments, client computer system 103 can be integrally coupled with electric vehicle 101, but other embodiments can exist where client computer system 103 is not integrally coupled with electric vehicle 101. For example, client computer system 103 can comprise a personal computer, such as a laptop or desktop computer, similar to computer system 200 (FIG. 2), as described below, comprising hardware and/or software configured to interface with system 100. In other examples, client computer system 103 can comprise a mobile electronic device, such as a smart phone, comprising hardware and/or software similarly configured to interface with system 100. In many embodiments, client computer system 103 can be configured to couple with one or more modules for and/or of electric vehicle 101, such as a global positioning system (GPS) module, a battery sensor module, and/or a vehicle computer system.

In a more detailed example, when client computer system 103 comprises a mobile electronic device (e.g., a smart phone), client computer system 103 can be configured to operate a mobile electronic device software application and to communicate with any user interface 130, charger computer system 112 and/or centralized computer system 199, each described in further detail below, using the mobile electronic device software application. The mobile electronic device software application can be configured to operate with one or more mobile electronic devices and/or mobile electronic device operating systems. The mobile electronic device software applications can be available (e.g., via computer download) for both member users and non-member users, as described below. With the mobile electronic device software application, user(s) 105 can receive information about any of vehicle charging station(s) 110 (e.g., availability), as described below, and charging status updates and notifications (e.g., start and duration of charging, charging completion, electrical fault, premature disconnection, etc.), via communication with any return module 115, any user interface 130, any charger computer system 112, and/or centralized computer system 199. as described herein. In some embodiments, the information can be received via e-mail and/or short messaging service (e.g., text message), as described herein, as opposed to through the mobile electronic device software application directly. Through the mobile electronic device software application and/or the user's profile, the user can determine how he or she prefers to receive the information.

The mobile electronic device software application can be configured to provide the user's current location automatically, using a wireless network connection and/or the global positioning module of the mobile electronic device, or manually, where user 105 manually provides a location (e.g., zip code, city, address, etc.), to return user interface 130, charger computer system 112, and/or centralized computer system 199. Upon receiving the current location, return module 115, user interface 130, charger computer system 112, and/or the centralized computer system 199 can provide the mobile electronic device software application and/or client computer system 103 with data from which to generate a map (e.g., similar or identical to the GUI map described above) of nearby vehicle charging stations of vehicle charging station(s) 110 (e.g., of the charging network), as well as driving directions to any of the vehicle charging stations of vehicle charging station(s) 110. By tapping on an icon on the map representing one vehicle charging station of vehicle charging station(s) 110, user 105 can view the availability (e.g., available, in use, and/or unavailable) and charging status of that vehicle charging station as well as additional details (e.g., the type of charging available (e.g., level 2 and/or level 3 charging), pricing, and information (e.g., local businesses, etc.) about the site of that electric vehicle charging station). Users(s) 105 can also define a default location, specify preferred units of measurement (e.g., Metric, Standard), and manage their accounts for the charging network using the mobile electronic device software application.

Referring now to FIG. 1, system 100 comprises one or more vehicle charging stations 110. Vehicle charging stations 110 comprise vehicle charging station 102 and/or vehicle charging station 150. Each vehicle charging station of the one or more vehicle charging stations 110 comprises its own electrical connector 111 configured to provide electricity to rechargeable energy storage system 117 of electric vehicle 101. In some embodiments, vehicle charging station 102, vehicle charging station 150, and/or any vehicle charging station of the one or more vehicle charging stations 110 can comprise its own second electrical connector 116.

In various embodiments, any vehicle charging station of the one or more vehicle charging stations 110 can comprise an electric vehicle supply equipment (e.g., a device for providing electricity to a rechargeable energy storage system (e.g., rechargeable energy storage system 117) of an electric vehicle (e.g., electric vehicle 101)). In other embodiments, any vehicle charging station of the one or more vehicle charging stations 110 can comprise an industrial electric charger (e.g., an on-board AC electric charger, a off-board DC electric charger). In still other embodiments, any vehicle charging station of the one or more vehicle charging stations 110 can be configured to transfer electricity to a rechargeable energy storage system of the at least one electric vehicle via electrical induction. Any vehicle charging station of the one or more vehicle charging stations 110 can comprise either of a stand-alone unit or a wall-mounted unit.

In various embodiments, the electric vehicle supply equipment can comprise a level 1 electric vehicle supply equipment, a level 2 electric vehicle supply equipment, and/or a level 3 electric vehicle supply equipment. The level 1 electric vehicle supply equipment can comprise either of a level 1 alternating current (AC) electric vehicle supply equipment or a level 1 direct current (DC) electric vehicle supply equipment. Meanwhile, the level 2 electric vehicle supply equipment can comprise either of a level 2 AC electric vehicle supply equipment or a level 2 DC electric vehicle supply equipment. Furthermore, the level 3 electric vehicle supply equipment can comprise either of a level 3 AC electric vehicle supply equipment or a level 3 DC electric vehicle supply equipment. In some embodiments, the level 2 electric vehicle supply equipment and/or the level 3 electric vehicle supply equipment can also be referred to as a fast charger. In many embodiments, the electric vehicle supply equipment can make available electricity comprising a maximum electric current of 30 amperes (A) or 48 A. When the maximum electric current of the electric vehicle supply equipment comprises 30 A, the electric vehicle supply equipment can be configured to make available electricity comprising an electric current of one or more of 12 A, 16 A, or 24 A. When the maximum electric current of the electric vehicle supply equipment comprises 48 A, the electric vehicle supply equipment can be configured to make available electricity comprising an electric current of one or more of 12 A, 16 A, 24 A, or 30 A.

For example, the level 1 AC electric vehicle supply equipment can make available electricity comprising an electric voltage of approximately 120 volts (V) and an electric current: greater than or equal to approximately 0 amperes (A) and less than or equal to approximately 12 A AC, when employing a 15 A breaker, or (b) greater than or equal to approximately 0 A and less than or equal to approximately 16 A AC, when employing a 20 A breaker. Accordingly, the level 1 electric vehicle supply equipment can comprise a standard grounded domestic electrical outlet. Meanwhile, the level 2 AC electric vehicle supply equipment can make available electricity comprising an electric voltage greater than or equal to approximately 208 V and less than or equal to approximately 240 V and an electric current greater than or equal to approximately 0 A and less than or equal to approximately 80 A AC. Furthermore, a level 3 electric vehicle supply equipment can make available electricity comprising an electric voltage greater than or equal to approximately 208 V and an electric current greater than or equal to approximately 80 A AC (e.g., 240 V AC (single phase), 208 V AC (triple phase), 480 V AC (triple phase). In some embodiments, the electric voltages for the level 1 electric vehicle supply equipment, the level 2 electric vehicle supply equipment, and/or the level 3 electric vehicle supply equipment can be within plus or minus (±) ten percent (%) tolerances of the electric voltages provided above.

In other examples, the level 1 DC electric vehicle supply equipment can provide electric power greater than or equal to approximately 0 kiloWatts (kW) and less than or equal to approximately 19 kW. Meanwhile, the level 2 DC electric vehicle supply equipment can provide electric power greater than or equal to approximately 19 kW and less than or equal to approximately 90 kW. Furthermore, level 3 electric vehicle supply equipment can provide electric power greater than or equal to approximately 90 kW. In some embodiments, the term fast charger can refer to an electric vehicle supply equipment providing electricity comprising an electric voltage between approximately 300 V-500 V and an electric current between approximately 100 A-400 A DC.

The industrial electric charger (e.g., the on-board AC electric charger, the off-board DC electric charger) can provide electric power greater than or equal to approximately 3 kW and less than or equal to approximately 33 kW. The off-board DC electric charger can provide electricity comprising an electric voltage greater than or equal to approximately 18 V DC and less than or equal to approximately 120 V DC.

In many embodiments, each electrical connector 111 and/or electrical connector 116 can each be coupled to its respective vehicle charging station of the one or more vehicle charging stations via its own electric cable. In many embodiments, electrical connector 111 and/or electrical connector 116 can comprise a J1772 standard electrical connector. In other embodiments, the electrical connector(s) can comprise an IEC 62196 electrical connector. In various embodiments, the electrical connector(s) can comprise a JARI Level 3 DC electrical connector. In many embodiments, the electric cable can be one of approximately 10, 12, 14, 16, 18, or 20 feet (3.1, 3.7, 4.3, 4.9, 5.5, or 6.1 meters) in length. Where a vehicle charging station of the one or more vehicle charging stations 110 comprises more than one electrical connector (e.g., electrical connector 111 and electrical connector 116), the vehicle charging station can simultaneously provide and/or receive electricity to and/or from a first rechargeable energy storage system 117 of a first electric vehicle 101 via electrical connector 111 and a second rechargeable energy storage system 117 of a second electric vehicle 101 via connector 116. In the same or different embodiments. In other embodiments, only one electrical connector of any vehicle charging station of the one or more vehicle charging stations 110 can provide/receive electricity at a time.

In many embodiments, rechargeable energy storage system 117 can comprise a device configured to store electricity for electric vehicle 101. In the same or different embodiments, the rechargeable energy storage system can comprise (a) one or more batteries and/or one or more fuel cells, (b) one or more capacitive energy storage systems (e.g., super capacitors such as electric double-layer capacitors), and/or (c) one or more inertial (e.g., flywheel) energy storage systems. In many embodiments, the one or more batteries can comprise one or more rechargeable (e.g., traction) and/or non-rechargeable batteries. For example, the one or more batteries can comprise one or more of a lead-acid battery, a valve regulated lead acid (VRLA) battery such as a gel battery and/or an absorbed glass mat (AGM) battery, a nickel-cadmium (NiCd) battery, a nickel-zinc (NiZn) battery, a nickel metal hydride (NiMH) battery, a zebra (e.g., molten chloroaluminate (NaAlCl₄)) and/or a lithium (e.g., lithium-ion (Li-ion)) battery. In some embodiments, where the rechargeable energy storage comprises more than one battery, the batteries can all comprise the same type of battery. In other embodiments, where the rechargeable energy storage system comprises more than one battery, the batteries can comprise at least two types of batteries. In many embodiments, the at least one fuel cell can comprise at least one hydrogen fuel cell.

In some embodiments, any vehicle charging station of the one or more vehicle charging stations 110 can comprise a public and/or a private vehicle charging station. In the same or different embodiments, vehicle charging station 102 comprises the public and/or private vehicle charging station. In this context, the adjectives public and private can generally be understood to modify vehicle charging station according to their conventional meanings, but in the interest of clarity, in various examples, the term “private vehicle charging station” may be understood to comprise a vehicle charging station that is not intended for commercial use (e.g., pecuniary gain) while the term “public vehicle charging station” may be understood to comprise a vehicle charging station that is intended for commercial use. In the same or different examples, the term “private vehicle charging station” may be understood to comprise a vehicle charging station that is reserved for use by a specific group of individuals (e.g., members of a family, members of a business, etc.) while the term “public vehicle charging station” may be understood to comprise a vehicle charging station that is not reserved for use by a specific group of individuals, i.e., the public vehicle charging station is available for use by the general population. Accordingly, in some examples, in an embodiment where any vehicle charging station of the one or more vehicle charging stations 110 comprises both public and private vehicle charging stations, that vehicle charging station of the one or more vehicle charging stations 110 can be understood to be public during certain periods of the day (e.g., during the day) and private during other periods of the day (e.g., during the night). Still, for any of these contexts, in some examples, either of the private and/or public vehicle charging station may be limited to use by a certain class of user 105 (e.g., users that are members of a charging network comprising the one or more vehicle charging stations 110, as described below) while in other examples, either of the private and/or public vehicle charging stations may be open to any user 105, regardless of his or her classification as a member of the charging network.

In many embodiments, as stated previously, user 105 can comprise one of a non-member user or a member user. In the same or different embodiments, the one or more vehicle charging stations 110 can be part of a charging network. The charging network can comprise an organization having one or more vehicle charging stations comprising the one or more vehicle charging stations 110. Accordingly, user 105 can become a member, i.e., the member user, of the charging network, such that user 105 comprises a member user of the charging network. In some embodiments, membership of the charging network can be a requirement for using the one or more vehicle charging stations 110 of the charging network (e.g., the one or more vehicle charging stations 110) and/or system 100. In other embodiments, membership of the charging network can be optional for using such charging stations, or such membership provides a discount for using such charging stations. In various embodiments, membership of the charging network can require some form of consideration (e.g., payment, or other) from user 105, but in other embodiments, membership of the charging network can be free of charge.

In various embodiments, when user 105 comprises the member user, user 105 can have an account and/or profile for the charging network. In many embodiments, the account comprises a serial number that uniquely associates each user 105 with his/her account. User 105 can utilize the account to access and use the charging network, and operators of the charging network can use the account to identify (e.g., authenticate, as described below) each user 105 and associate any transactions of electricity with the particular user 105. In some embodiments, the account can be related to multiple users (e.g., a family) comprising user 105. In other embodiments, the account can be related to a single user 105.

In the same or different embodiments, the profile can comprise information relating to the user 105 associated with the profile and/or with electric vehicle 101 of user 105. For example, the profile can comprise personal information of user 105 (e.g., name, contact information, bank account numbers, etc.), vehicular information of electric vehicle 101 (e.g., a make, model, and/or year of electric vehicle 101, a vehicle identification number of electric vehicle 101, a type of rechargeable energy storage system 117, as described below, of electric vehicle 101, an odometer reading of electric vehicle 101, data relating to historic distances traveled per quantity of charge of rechargeable energy storage system 117, etc.), and/or a history of use of user 105 (e.g., data on previous transactions with the charging network, one or more preferred vehicle charging stations of the one or more vehicle charging stations 110, one or more preferred times/dates on which to use at least one vehicle charging station of the one or more vehicle charging stations 110, etc.).

In many embodiments, when user 105 comprises a member user and/or when electric vehicle 101 comprises an electric vehicle of user 105, client 104 can comprise a member client. When a client 104 comprises the member client, client 104 can be entitled to certain advantages compared to a second client comprising a non-member client. For example, in some embodiments, when client 104 comprises the member client, client 104 can be permitted to use system 100 whereas the second client cannot. In further embodiments, client 104 can be given preference for reservation times, or can be given a discounted price, compared to the second client. For these examples, in some embodiments, when client 104 and the second client are waiting to use vehicle charging station 102, client 104 would be placed ahead of the second client even if the second client requested a reservation prior to client 104. In other embodiments, client 104 can request a reservation for a time already assigned to the second client.

Referring again to FIG. 1, each vehicle charging station of the one or more vehicle charging stations 110 comprises its own charger computer system 112 configured to communicate with client computer system 103. As illustrated in FIG. 1, in many embodiments, charger computer system 112 can be integrally coupled with its respective vehicle charging station of the one or more vehicle charging stations 110, but other embodiments can exist where charger computer system 112 is not integrally coupled with its respective vehicle charging station of the one or more vehicle charging stations 110 (e.g., where charger computer system is coupled with its respective vehicle charging station via a wired and/or wireless connection). In the same or different embodiments, each vehicle charging station of the one or more vehicle charging stations 110 can comprise user interface 130. In some embodiments, user interface 130 can be configured to communicate with user 105 and/or with charger computer system 112 of the vehicle charging station of the one or more vehicle charging stations 110 that comprises the user interface 130. In various embodiments, user interface 130 can comprise a touch screen display or an analogous device capable of receiving and/or providing information to and/or from user 105.

In many embodiments, system 100 can comprise centralized computer system 199. In other embodiments, centralized computer system 199 is not part of system 100 but can be configured to communicate with system 100, client computer system 103, and/or charger computer system 112. In many embodiments, centralized computer system 199 can be configured to provide central control of system 100 to coordinate communications between each charger computer system 112 and client computer system 103. For example, centralized computer system 199 can provide a central hub through which communications can be routed to/from client computer system 103 from/to at least one charger computer system 112. In many embodiments, centralized computer system 199, each charger computer system 112, and/or client computer system 103 can be configured to communicate with each other via a wired and/or wireless computer network or a cellular telephone network.

In some instances, charger computer system 112 is similar to a dummy terminal that merely receives input from client 104 for centralized computer system 199 and outputs data from centralized computer system 199 to client 104. In these instances, charger computer system 112 of different vehicle charging stations 112 do not communicate with each other. In some embodiments, charger computer system 112 can comprise optical recognition device 113, communications module 114, and/or return module 115, as explained in detail below.

In some embodiments, centralized computer system 199 can comprise at least one computer database 198. For example, the at least one computer database 198 can be implemented as one or more of an XML (Extensible Markup Language) database, MySQL, or an Oracle® database. In various embodiments, centralized computer system 199 can be configured to continuously update in real time the at least one computer database 198 with reservation data. For example, reservation data can comprise locations, availability, and/or capacity of the one or more vehicle charging stations 110, one or more desired times requested by client computer system 103, a charge level of chargeable energy storage system 117 of electric vehicle 101, a location of electric vehicle 101, a planned route of electric vehicle 101, a distance between the location of electric vehicle 101 and one or more vehicle charging stations of the one or more vehicle charging stations 110, an estimated time of arrival of client 104 at one or more vehicle charging stations of the one or more vehicle charging stations 110, and/or one or more estimated charge times for rechargeable energy storage system 117 of electric vehicle 101, based on the charge level of rechargeable energy storage system 117 of electric vehicle 101 and/or the location of electric vehicle 101. In some embodiments, centralized computer system 199 can be configured to collect some or all of the reservation data directly from client computer system 103 and/or at least one charger computer system 112. In the same or different embodiments, centralized computer system 199 can be configured to collect third-party data (e.g., energy and demand data, etc.) from one or more computer systems of a third party (e.g., a utility company) and/or incomplete reservation data (e.g., data requiring that one or more mathematical operations and variables are applied to the data in order for it to comprise the reservation data) and to use the third-party data and/or the incomplete reservation data to determine some or all of the reservation data (e.g., such as where the third-party data provides one or more of the variables for the incomplete reservation data).

In further embodiments, computer database 198 can be configured to store the above described profile and/or account information of at least one user 105. In further embodiments, computer database 198 can be configured to store transactional data (e.g., bills, and other accounting information) relating to the at least one user 105.

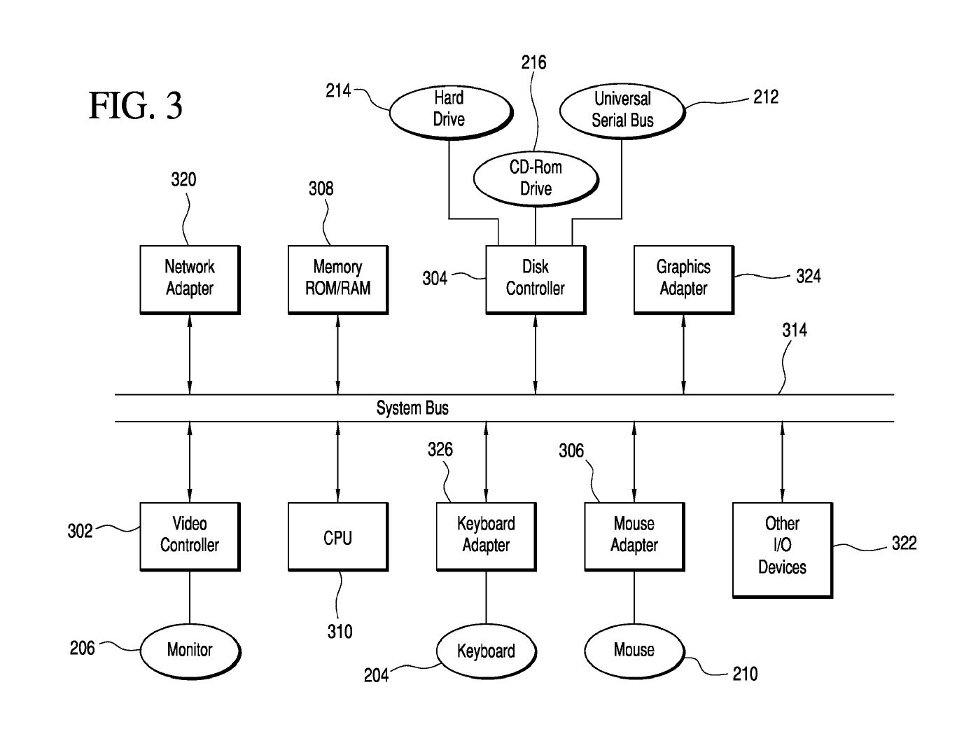

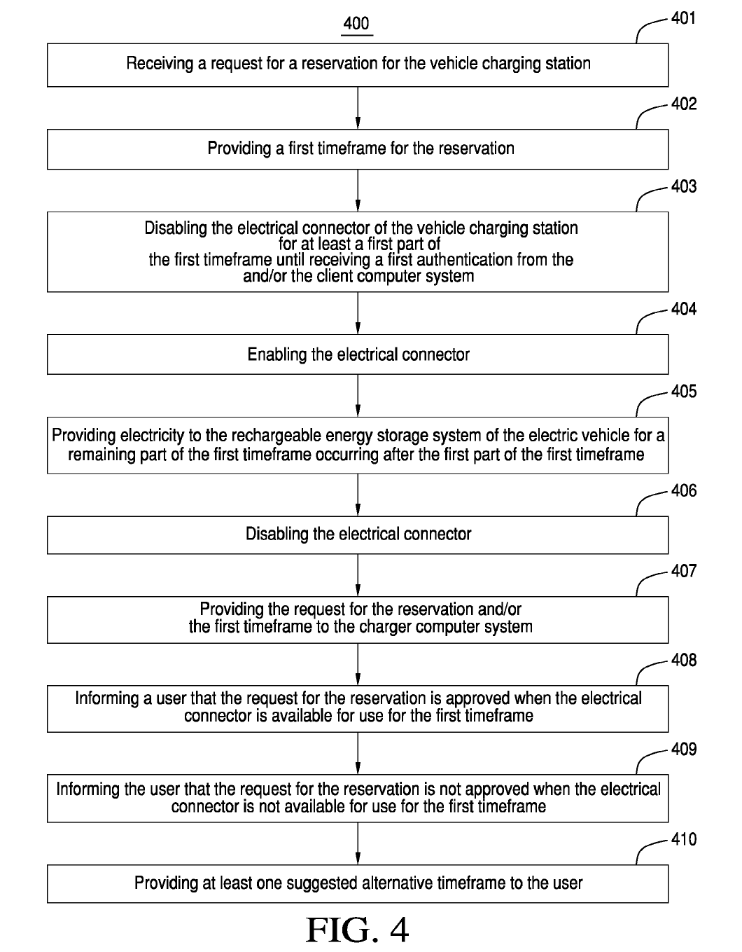

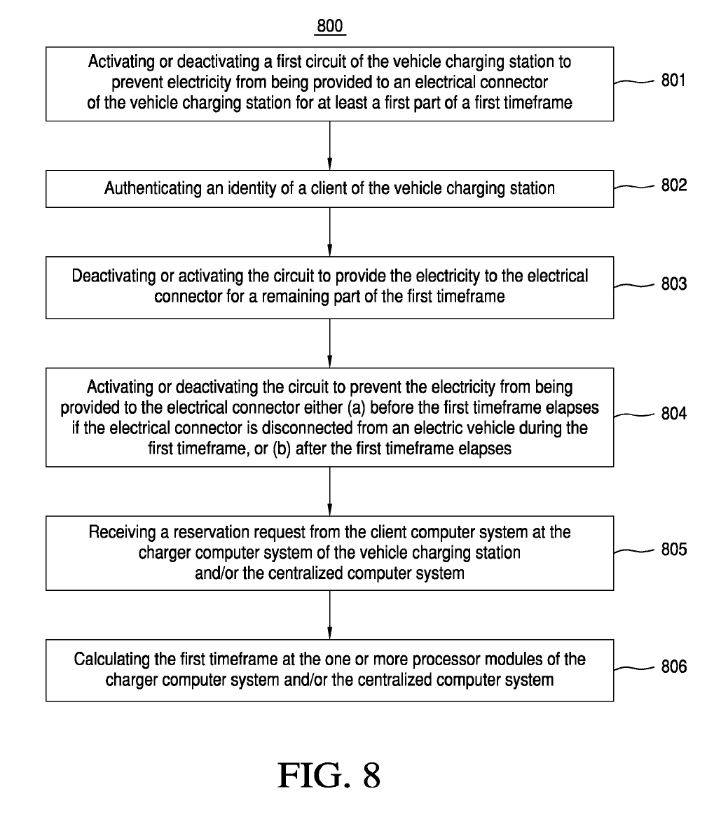

Returning now to the drawings, FIG. 2 illustrates an exemplary embodiment of computer system 200 that can be suitable for implementing an embodiment of client computer system 103, charger computer system 112, and/or centralized computer system 199 and/or at least part of system 100 (FIG. 1), method 400 (FIG. 4), and/or method 800 (FIG. 8). Computer system 200 includes chassis 202 containing one or more circuit boards (not shown), Universal Serial Bus (USB) 212, Compact Disc Read-Only Memory (CD-ROM) and/or Digital Video Disc (DVD) drive 216, and hard drive 214. A representative block diagram of the elements included on the circuit boards inside chassis 202 is shown in FIG. 3. Central processing unit (CPU) 310 in FIG. 3 is coupled to system bus 314 in FIG. 3. In various embodiments, the architecture of CPU 310 can be compliant with any of a variety of commercially distributed architecture families.

System bus 314 also is coupled to memory 308, where memory 308 includes both read only memory (ROM) and random access memory (RAM). Non-volatile portions of memory 308 or the ROM can be encoded with a boot code sequence suitable for restoring computer system 200 (FIG. 2) to a functional state after a system reset. In addition, memory 308 can include microcode such as a Basic Input-Output System (BIOS). In some examples, the one or more storage modules of the various embodiments disclosed herein can include memory 308, USB 212 (FIGS. 2-3), hard drive 214 (FIGS. 2-3), and/or CD-ROM or DVD drive 216 (FIGS. 2-3). In the same or different examples, the one or more storage modules of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Examples of common operating systems can include Microsoft® Windows, Mac® operating system (OS), UNIX® OS, and Linux® OS. Common operating systems for a mobile electronic device include the iPhone® operating system by Apple Inc. of Cupertino, Calif., the Blackberry® operating system by Research In Motion (RIM) of Waterloo, Ontario, Canada, the Palm® operating system by Palm, Inc. of Sunnyvale, Calif., the Android operating system developed by the Open Handset Alliance, the Windows Mobile operating system by Microsoft Corp. of Redmond, Wash., or the Symbian operating system by Nokia Corp. of Espoo, Finland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions.

In the depicted embodiment of FIG. 3, various I/O devices such as disk controller 304, graphics adapter 324, video controller 302, keyboard adapter 326, mouse adapter 306, network adapter 320, and other I/O devices 322 can be coupled to system bus 314. Keyboard adapter 326 and mouse adapter 306 are coupled to keyboard 204 (FIGS. 2-3) and mouse 210 (FIGS. 2-3), respectively, of computer system 200 (FIG. 2). While graphics adapter 324 and video controller 302 are indicated as distinct units in FIG. 3, video controller 302 can be integrated into graphics adapter 324, or vice versa in other embodiments. Video controller 302 is suitable for refreshing monitor 206 (FIGS. 2-3) to display images on a screen 208 (FIG. 2) of computer system 200 (FIG. 2). Disk controller 304 can control hard drive 214 (FIGS. 2-3), USB 212 (FIGS. 2-3), and CD-ROM drive 216 (FIGS. 2-3). In other embodiments, distinct units can be used to control each of these devices separately.

In some embodiments, network adapter 320 can be part of a WNIC (wireless network interface controller) card (not shown) plugged or coupled to an expansion port (not shown) in computer system 200. In other embodiments, the WNIC card can be a wireless network card built into computer system 200. A wireless network adapter can be built into computer system 200 by having wireless Ethernet capabilities integrated into the motherboard chipset (not shown), or implemented via a dedicated wireless Ethernet chip (not shown), connected through the PCI (peripheral component interconnector) or a PCI express bus. In other embodiments, network adapter 320 can be a wired network adapter.

Although many other components of computer system 200 (FIG. 2) are not shown, such components and their interconnection are well known to those of ordinary skill in the art. Accordingly, further details concerning the construction and composition of computer system 200 and the circuit boards inside chassis 202 (FIG. 2) are not discussed herein.

When computer system 200 in FIG. 2 is running, program instructions stored on a USB equipped electronic device connected to USB 212, on a CD-ROM or DVD in CD-ROM and/or DVD drive 216, on hard drive 214, or in memory 308 (FIG. 3) are executed by CPU 310 (FIG. 3). A portion of the program instructions, stored on these devices, can be suitable for carrying out at least part of methods 400 and/or 800 (FIGS. 4 & 8) and one or more functions of system 100.

Although computer system 200 is illustrated as a desktop computer in FIG. 2, there can be examples where computer system 200 may take a different form factor (e.g., laptop, mobile electronic device, etc.) while still having functional elements similar to those described for computer system 200. In some embodiments, computer system 200 may comprise a single computer, a single server, or a cluster or collection of computers or servers, or a cloud of computers or servers.

Returning now to FIG. 1, in various embodiments, client computer system 103 provides the request for the reservation of time to at least one charger computer system 112 of the one or more vehicle charging stations 110 and/or to centralized computer system 199. In other embodiments, user 105 provides the request for the reservation of time to the charger computer system 112 of one vehicle charging station of the one or more vehicle charging stations 110 (e.g., vehicle charging station 102) directly via user interface 130. In many embodiments, the at least one charger computer system 112 of the one or more vehicle charging stations 110 and/or centralized computer system 199 are configured to determine at least one timeframe for the request for the reservation of time after receiving the request for the reservation of time. In some embodiments, the at least one charger computer system 112 of the one or more vehicle charging stations 110 and/or centralized computer system 199 can be configured to determine at least one timeframe for the request for the reservation of time after receiving the request for the reservation of time based on the incomplete reservation data, the third-party data, the reservation data, and/or the profile of user 105. The request for the reservation of time can comprise one or more specifically requested times and days (e.g., 7:00-8:00 p.m. on Mar. 4, 2015) in some embodiments and/or can comprise one or more arbitrarily requested timeframes (e.g., one hour) in other embodiments such as where the request for the reservation of time is based on, for example, a quantity of desired charge for rechargeable energy storage system 117 and/or one or more other variable parameters (e.g., distance from vehicle charging station 102) as opposed to a specifically requested time (i.e. the quantity of desired charge for rechargeable energy storage system 117 will require one hour to complete by the time electric vehicle 101 arrives at vehicle charging station 102). In some embodiments, client computer system 103 can provide the request for the reservation of time to the charger computer system 112 of vehicle charging station 102 at which time charger computer system 112 can relay the request for the reservation of time to centralized computer system 199 such that centralized computer system 199 can reference the reservation data to determine the at least one timeframe. In other embodiments, charger computer system 112 can determine the at least one timeframe locally, and charger computer system 112 can provide the reservation data to the centralized computer system 199 for reference, upon a request communicated to centralized computer system 199 by charger computer system 112 when charger computer system 112 receives the request for the reservation of time from client computer system 103 and/or automatically upon regular intervals.

In the same or different embodiments, if electrical connector 111 of vehicle charging station is reserved, as determined by reference to the reservation data, during a first timeframe (as determined above by, for example, charger computer system 112 of vehicle charging station 102 and/or centralized computer system 199), charger computer system 112 of vehicle charging station 102 is configured to deactivate the corresponding electrical connector 111 for at least a first part of the first timeframe until charger computer system 112 of vehicle charging station 102 receives an authentication from client 104 and/or client computer system 103 that created the reservation. Pursuant to that same reservation, vehicle charging station 102 can be configured to provide electricity to electrical connector 111 of vehicle charging station 102 after the charger computer system 112 of vehicle charging station 102 receives the authentication from client 104 and/or client computer system 103 at least until the first timeframe elapses, but in some examples, prior to when the first timeframe elapses such as where user 105, client 104, charger computer system 112, and/or client computer system 103 terminates the transaction (e.g., electrical connector 111 is disconnected from rechargeable energy storage system 117, rechargeable energy storage system 117 becomes fully charged, a maximum charge time and/or cost of the charge provided by user 105, client 104, and/or client computer system 103 is reached, etc.). In some embodiments, vehicle charging station 102 can be configured to continue to provide electricity to electrical connector 111 of vehicle charging station 102 after the first timeframe elapses if doing so will not conflict with a reservation of vehicle charging station 102 by another client 104 and/or user 105.

In many embodiments, user 105 can be given an established period of time to move electric vehicle 101 away from vehicle charging station 102 and/or to disconnect electrical connector 111 of vehicle charging station 102 from electric vehicle 101 after the first timeframe elapses and/or after the charge completes, before user 105 can be assessed a penalty in order to ensure that electrical connector 111 and/or vehicle charging station 102 is available for reservations of other users. In some embodiments, the first part of the first timeframe can be adjusted based on the amount of time before user 105 moves electric vehicle 101 and/or disconnects the electrical connector 111 of vehicle charging station 102 from electric vehicle 101. In some embodiments, the penalty can comprise a fine and/or towing the vehicle. In various embodiments, the fine can be assessed to the account of user 105 and/or to the current transaction of electricity. In the same or different embodiments, charger computer system 112 and/or return module 115, as described below, can be configured to automatically inform a tow truck to tow the vehicle after the established period of time passes and a predetermined grace period (e.g., 5 minutes, 10 minutes, 15 minutes, or 20 minutes) beyond the established period of time also passes. In still other embodiments, user 105 can be fined for failing to show up for his or her reservation at all or within a predetermined first part of the first timeframe. In various embodiments, any fines assessed to user 105 can be at least a minimum fee and/or can be assessed by the cost of the electricity per minute multiplied by the number of minutes that the vehicle charging station of the one or more vehicle charging stations 110 was made unavailable to another user. In the same or different embodiments, charger computer system 112 and/or return module 115, as described below, can be configured to automatically inform user 105 (by email, short message service (e.g., text message), social networking, telephone call, output from software on client computer system 103, etc.), that a fine will be assessed or electric vehicle 101 will be towed if user 105 does not move electric vehicle 101 from vehicle charging station 102 and/or disconnect the electrical connector 111 of vehicle charging station 102 from electric vehicle 101 after the first timeframe elapses and/or the charge completes.

For example, if electrical connector 111 of vehicle charging station 102 is available (i.e., electrical connector 111 is not reserved and/or not presently being used to charge rechargeable energy storage system 117 of an electric vehicle other than electric vehicle 101) during some period of time equal to or less than and/or during or partially during the at least one timeframe for the request for the reservation of time, charger computer system 112 of vehicle charging station 102 can deactivate electrical connector 111 and/or vehicle charging station 102 for all or part of the first timeframe of the at least one timeframe, thereby providing the reservation of vehicle charging station 102 and/or its electrical connector 111 for the first timeframe. In various examples, charger computer system 112 only deactivates the vehicle charging station 102 and/or electrical connector 111 for part of the first timeframe (e.g., the first 5 minutes, 10 minutes, 15 minutes, 20 minutes, etc.) while it waits to receive the first authentication from client 104. Accordingly, if charger computer system 112 fails to receive the first authentication from client 104 during the first part of the first timeframe, charger computer system 112 can cancel the reservation for the remainder of the first timeframe such that another client 104 can immediately begin to use and/or reserve vehicle charging station 102 for the remainder of the first timeframe.

In many embodiments, the first part of the first timeframe and a time reserved by the request for the reservation of time begin simultaneously with each other. For example, in many embodiments, the first part of the first timeframe comprises a beginning period of the timeframe reserved by the request for the reservation, thereby providing a period of time during which user 105 can provide authentication to confirm his or her reservation, as described above.

In some embodiments, charger computer system 112 of vehicle charging station 102 can reference the reservation data to determine whether electrical connector 111 of vehicle charging station 102 is available for reservation after receiving the reservation data from centralized computer station 199 and can deactivate the corresponding electrical connector 111 of vehicle charging station 102 for at least a first part of the first timeframe according to its findings. In other embodiments, centralized computer system 199 can reference the reservation data to determine whether electrical connector 111 of vehicle charging station 102 is available for reservation after receiving the reservation data from centralized computer station 199 and can send a command to the corresponding charger computer system 112 of vehicle charging station 102 instructing charger computer system 112 to deactivate electrical connector 111 of vehicle charging station 102 for at least a first part of the first timeframe according to its findings.

Referring back to FIG. 1, in some embodiments, each charger computer system 112 of each vehicle charging station of the one or more vehicle charging stations 110 and/or centralized computer system 199 can comprise return module 115. Return module 115 can be configured to communicate with client computer system 103. In some embodiments, return module 115 can be configured to inform user 105 (e.g., via client computer system 103—email, short message service (e.g., text message), social networking, telephone call, output from software on client computer system 103, etc.) that the request for the reservation of time is approved if electrical connector 111 of the at least one vehicle charging station of the one or more vehicle charging stations 110 (e.g., vehicle charging station 102) is available for the first timeframe. In the same or different embodiments, return module 115 can be configured to inform user 105 (e.g., via client computer system 103—email, short message service (e.g., text message), social networking, telephone call, output from software on client computer system 103, etc.) that the request for the reservation of time is not approved if the electrical connector 111 of the at least one vehicle charging station is not available during the first timeframe. In the same or different embodiments, return module 115 can be configured to provide at least one suggested alternative timeframe (e.g., another timeframe within the at least one timeframe) at the same and/or different vehicle charging stations of the one or more vehicle charging stations 110 to user 105 if the electrical connector 111 of vehicle charging station 102 is not available during the first timeframe. In some embodiments, return module 115 corresponding to whichever of any charger computer system 112 or to the centralized computer system 199 that determines if electrical connector 111 of vehicle charging station 102 is available can be configured to inform user 105 regarding the availability of electrical connector 111 and/or regarding the at least one suggested alternative timeframe for electrical connector 111. In some embodiments, return module 115 can be configured to inform user 105 (e.g., via client computer system 103—email, short message service (e.g., text message), social networking, telephone call, output from software on client computer system 103, etc.) that the reservation timeframe and/or the charge is complete.

In many embodiments, the authentication from client 104 and/or client computer system 103 can comprise an optical recognition image capture of at least part of user 105 (e.g., a face, a fingerprint, a retina scan, etc.) and/or of electric vehicle 101 (e.g., a license plate, a VIN number, etc.) and/or can comprise a signal where the signal comprises the account number (or another serial number associated with the account and/or account number) of user 105, as described above. In other embodiments, the authentication from client 104 and/or client computer system 103 can comprise a code comprised of letters, numbers, and/or symbols provided to charger computer system 112 of the at least one vehicle charging station of the one or more vehicle charging stations 110 by user 105. In some embodiments, the signal can be encoded with the signal and/or encrypted for security purposes.

Referring back to FIG. 1, in the same or different embodiments, each charger computer system 112 of each vehicle charging station 102 of the one or more vehicle charging stations 110 can comprise optical recognition device 113 and/or communications module 114. In some embodiments, communications module 114 can be configured to receive the signal authenticating user 105 from at least one of a sonic transceiver, an infrared transceiver, a radio frequency identification (RFID) transceiver, a Bluetooth device, a wireless modem, or a cable coupled to charger computer system 112. Accordingly, user 105 can provide a device (e.g., a key fob, a laptop computer, a mobile electronic device such as a smartphone, etc.) comprising one or more of the sonic transceiver, the infrared transceiver, the RFID transceiver, the Bluetooth device, the wireless modem, or the cable by which to couple the device to charger computer system 112 in order to provide the signal to charger system 112 for purposes of authentication. In some embodiments, each charger computer system 112 can comprise a proximity sensor to determine the presence of a vehicle (e.g., electric vehicle 101).

In many embodiments, when the at least one vehicle charging station of the one or more vehicle charging stations 110 comprises at least one more electrical connector (e.g., electrical connector 116) in addition to electrical connector 111, charger computer system 112 of the at least one vehicle charging station of the one or more vehicle charging stations 110 (e.g., vehicle charging station 102) can be configured to deactivate electrical connector 116 while providing electricity to rechargeable energy storage system 117 of electric vehicle 101 with electrical connector 111. In other embodiments, the at least one vehicle charging station can be configured to provide electricity to rechargeable energy storage system 117 of electric vehicle 101 via electrical connector 111 while simultaneously providing electricity to a rechargeable energy storage system of at least one other electric vehicle via the at least one more electrical connector. For example, in many embodiments, configuring the at least one vehicle charging station with at least one more electrical connector than electrical connector 111 is intended to permit the at least one vehicle charging station to provide electricity to at least one other electric vehicle (other than electric vehicle 101) when electrical connector 111 is inaccessible and/or unavailable (e.g. remains connected to electric vehicle 101) and/or is not providing electricity to rechargeable energy storage system 117 of electric vehicle 101, i.e., electric vehicle 101 has not yet been disconnected and/or moved from the at least one vehicle charging station.

In many embodiments, the charger computer system 112 of the at least one vehicle charging station of the one or more vehicle charging stations 110 and/or centralized computer system 199 can determine multiple timeframes for the request for one or more requests for reservations of time after receiving one or more requests for the reservations of time from client computer system 103 and/or user 105. In the same or different embodiments, the at least one charger computer system 112 of the one or more vehicle charging stations 110 and/or centralized computer system 199 can be configured to determine if electrical connector 111 of any of the at least one vehicle charging station of the one or more vehicle charging stations 110 is available for reservation during two or more timeframes of the multiple timeframes. In the same or different embodiments, the at least one vehicle charging station can comprise multiple charging stations of the one or more vehicle charging stations 110 (e.g., vehicle charging station 102 and vehicle charging station 150), and the two or more timeframes of the multiple timeframes can be split between the multiple charging stations of the one or more vehicle charging stations 110. In the same or different embodiments, the two or more timeframes of the multiple timeframes can be for one of the at least one vehicle charging station. For example, centralized computer system 199 could determine three timeframes upon receiving the one or more requests for reservations of time from client computer system 103. Centralized computer system 199 could then determine: (a) two timeframes of the two or more timeframes of the multiple timeframes during which electrical connector 111 of a first vehicle charging station (e.g., vehicle charging station 102) of the at least one vehicle charging station of the one or more vehicle charging stations 110 is available; and (b) one timeframe of the two or more timeframes of the multiple timeframes during which electrical connector 111 of a second vehicle charging station (e.g., vehicle charging station 150) of the at least one vehicle charging station of the one or more vehicle charging stations 110 is available. Accordingly, centralized computer system 199 could send: (a) a first command to vehicle charging station 102 to deactivate its electrical connector 111 for the two timeframes of the two or more timeframes; and (b) a second command to vehicle charging station 150 to deactivate its electrical connector 111 for the one timeframe of the two or more timeframes. Accordingly, user 105 could authenticate himself or herself at the vehicle charging station 102 to charge electric vehicle 101 for a first timeframe of the two timeframes of the one or more timeframes, then he or she could leave and return to vehicle charging station 102 to once again authenticate himself or herself to charge electric vehicle 101 for a second timeframe of the two timeframes of the one or more timeframes, and then could move to vehicle charging station 150 to again authenticate himself or herself and charge electric vehicle 101 for a third time frame comprising the one timeframe of the two or more timeframes.

FIG. 4 illustrates a flow chart for an embodiment of method 400 for coordinating a reservation for a vehicle charging station via communications between a client computer system of a client and a charger computer system. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of the method 400 can be performed in any other suitable order. In still other embodiments, one or more of the procedures, the processes, and/or the activities in method 400 can be combined or skipped. In some embodiments, method 400 or any of the procedures, the processes, and/or the activities of method 400 can be performed in real time.

In many embodiments, the vehicle charging station, the client computer system, and/or the charger computer system can be similar or identical to vehicle charging stations 102 and/or 150 (FIG. 1), client computer system 103 (FIG. 1), and/or charger computer system 112 (FIG. 1), respectively. In various embodiments, method 400 can be implemented via execution of computer instructions configured to run at one or more processing modules and/or configured to be stored at one or more storage modules. In various embodiments, the computer instructions can be implemented on a computer system similar or identical to computer system 200 (FIG. 2), and the one or more processing modules and/or the one or more storage modules can be similar or identical to the processing modules and/or storage modules described above with respect to computer system 200. In some embodiments, the one or more processing modules can comprise one processing module and/or the one or more storage modules can comprise one storage module. In the same or different embodiments, the client can be similar or identical to client 104 (FIG. 1).

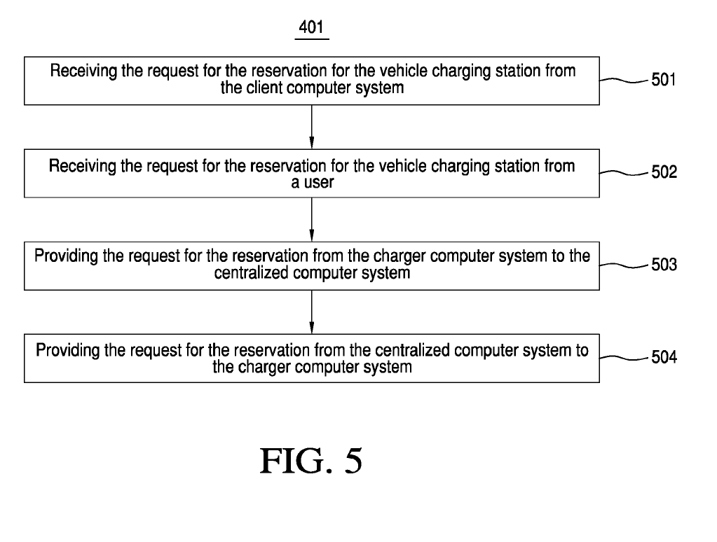

Referring now to FIG. 4, in some embodiments, method 400 can comprise procedure 401 of receiving a request for a reservation for the vehicle charging station. FIG. 5 illustrates procedure 401 according to an embodiment.

Referencing FIG. 5, procedure 401 (FIG. 4) can comprise process 501 of receiving the request for the reservation for the vehicle charging station from the client computer system. In other embodiments, procedure 401 (FIG. 4) can comprise process 502 of receiving the request for the reservation for the vehicle charging station from a user. In some embodiments, the client computer system can be similar or identical to client computer system 103 (FIG. 1). In some embodiments, the user of process 502 can be similar or identical to user 105 (FIG. 1). When process 501 occurs, process 502 can be omitted, and vice versa. In some embodiments, procedure 401 (FIG. 4) can occur at or be performed by the one or more processor modules of the charger computer system and/or a centralized computer system. In the same or different embodiments, when procedure 401 (FIG. 4) occurs at the one or more processor modules of the charger computer system and of the centralized computer system, procedure 401 can comprise one of: (a) a process 503 of providing the request for the reservation from the charger computer system to the centralized computer system; or (b) a process 504 of providing the request for the reservation from the centralized computer system to the charger computer system. In the same or different embodiments, the centralized computer system of process 501 can be similar or identical to centralized computer system 199 (FIG. 1).

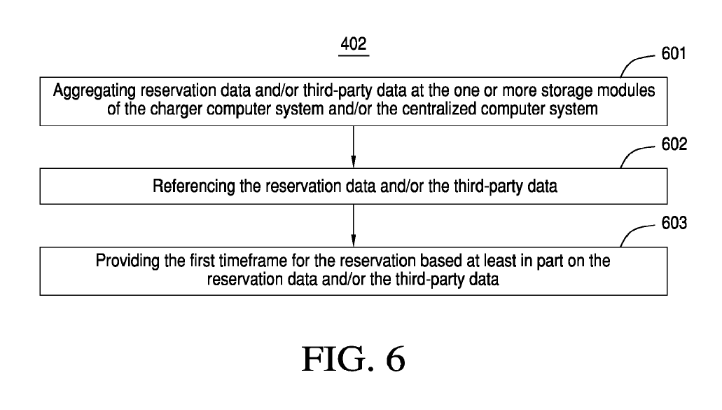

Referring back to FIG. 4, in some embodiments, method 400 can comprise procedure 402 of providing a first timeframe for the reservation. In some embodiments, procedure 402 can occur at the one or more processor modules of the charger computer system and/or the centralized computer system. FIG. 6 illustrates procedure 402 according to an embodiment.

Referencing FIG. 6, procedure 402 (FIG. 4) can comprise process 601 of aggregating reservation data and/or third-party data at the one or more storage modules of the charger computer system and/or the centralized computer system. In the same or different embodiments, procedure 402 (FIG. 4) can comprise process 602 of referencing the reservation data and/or the third-party data. In the same or different embodiments, procedure 402 (FIG. 4) can comprise process 603 of providing the first timeframe for the reservation based at least in part on the reservation data and/or the third-party data. In the same or different embodiments, the reservation data and/or the third-party data of process 601 can be similar or identical to the reservation data and/or the third-party data described above with respect to system 100 (FIG. 1).

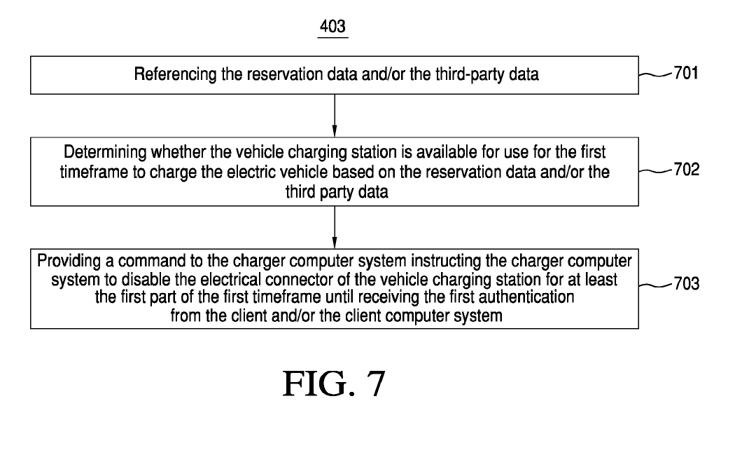

Referring back to FIG. 4 again, in some embodiments, method 400 can comprise procedure 403 of disabling the electrical connector of the vehicle charging station for at least a first part of the first timeframe until receiving a first authentication from the client and/or the client computer system. In many embodiments, procedure 403 can be performed and/or can occur if the vehicle charging station is available for use for the first timeframe to charge the electric vehicle. In some embodiments, procedure 403 can occur at the one or more processors of the charger computer system and/or the centralized computer system. In some embodiments, the first part of the first timeframe and the first timeframe can begin simultaneously with each other. In various embodiments, the electric vehicle of procedure 403 can be similar or identical to electric vehicle 101 (FIG. 1). FIG. 7 illustrates procedure 403 according to an embodiment.

Referencing FIG. 7, procedure 403 (FIG. 4) can comprise process 701. Process 701 can be similar or identical to process 602 (FIG. 6). In various embodiments, process 701 and process 602 (FIG. 6) may be conducted simultaneously and/or may be the same process. In many embodiments, procedure 403 (FIG. 4) can comprise process 702 of determining whether the vehicle charging station is available for use for the first timeframe to charge the electrical vehicle based on the reservation data and/or the third-party data. In many embodiments, process 702 can occur at the one or more processors of the charger computer system and/or the centralized computer system. In the same or different embodiments, when process 702 occurs at the one or more processors of the centralized computer system, procedure 403 (FIG. 4) can comprise process 703 of providing a command to the charger computer system instructing the charger computer system to disable the electrical connector of the vehicle charging station for at least the first part of the first timeframe until receiving the first authentication from the client and/or the client computer system that previously made the reservation. In some embodiments, the electrical connector of process 703 can be similar to electrical connector 111 (FIG. 1) and/or electrical connector 116 (FIG. 1). In the same or different embodiments, the first authentication of process 703 can be similar or identical to the authentication described above with respect to system 100 (FIG. 1).

Referring again to FIG. 4, in some embodiments, method 400 can comprise procedure 404 of enabling the electrical connector. In many embodiments, procedure 404 can be performed and/or can occur after receiving the first authentication.

Referring again to FIG. 4, in some embodiments, method 400 can comprise procedure 405 of providing electricity to the rechargeable energy storage system of the electric vehicle for a remaining part of the first timeframe occurring after the first part of the first timeframe. In various embodiments, procedure 405 can be performed and/or can occur after procedure 403 occurs and/or is performed. In further embodiments, procedure 405 can be performed and/or can occur after or approximately when procedure 404 occurs and/or is performed. In some embodiments, the rechargeable energy storage system of procedure 405 can be similar or identical to rechargeable energy storage system 117 (FIG. 1).

Referring again to FIG. 4, in some embodiments, method 400 can comprise procedure 406 of disabling the electrical connector. In some embodiments, procedure 406 can be performed and/or can occur after and/or when procedure 405 is complete. In various embodiments procedure 406 can be performed and/or can occur before the first timeframe elapses (e.g., when the electrical connector is disconnected prior to completion of the first timeframe), when the first timeframe elapses (e.g., when the electrical connector is reserved for the time period directly after the first timeframe by another user), or after the first timeframe elapses (e.g., when the electrical connector is not otherwise being used/reserved after the first timeframe elapses).

Referring again to FIG. 4, in some embodiments, method 400 can comprise procedure 407 of providing the request for the reservation and/or the first timeframe to the charger computer system. In some embodiments, procedure 407 can be performed as process 504 (FIG. 5), as described above. In various embodiments, procedure 407 can be performed and/or can occur after and/or when procedure 401 occurs at the one or more processor modules of the centralized computer system. In other embodiments, procedure 407 can be omitted.

Referring again to FIG. 4, in some embodiments, method 400 can comprise procedure 408 of informing a user that the request for the reservation is approved when the electrical connector is available for use for the first timeframe. In other embodiments, method 400 can comprise procedure 409 of informing the user that the request for the reservation is not approved when the electrical connector is not available for use for the first timeframe. In some embodiments, method 400 can comprise procedure 410 of providing at least one suggested alternative timeframe or alternative electrical connector or vehicle charging station to the user. In many embodiments, one or more of procedure 408, procedure 409, or procedure 410 can be omitted from method 400.

In many embodiments, one or more of procedures 401-410 can be repeated at least once for one or more timeframes for at least one additional reservation. In various embodiments, the one or more of procedures 401-410 can be repeated for the same vehicle charging station. In the same or different embodiments, the vehicle charging station can have one or more additional electrical connectors, and the one or more procedures 401-410 can be repeated for at least one electrical connector of the one or more additional electrical connectors. In other embodiments, the one or more of procedures 401-410 can be repeated for one or more different vehicle charging stations.

FIG. 8 illustrates a flow chart for an embodiment of method 800 for operating a vehicle charging station. Method 800 is merely exemplary and is not limited to the embodiments presented herein. Method 800 can be employed in many different embodiments or examples not specifically depicted or described herein. In some embodiments, the procedures, the processes, and/or the activities of method 800 can be performed in the order presented. In other embodiments, the procedures, the processes, and/or the activities of the method 800 can be performed in any other suitable order. In still other embodiments, one or more of the procedures, the processes, and/or the activities in method 800 can be combined or skipped. In some embodiments, method 800 or any of the procedures, the processes, and/or the activities of method 800 can be performed in real time. In many embodiments, all or part of method 800 can be similar or identical to method 400 (FIG. 4). In various embodiments, the vehicle charging station can be similar or identical to vehicle charging station 102 (FIG. 1).

In various embodiments, method 800 can be implemented via execution of computer instructions configured to run at one or more processing modules and/or configured to be stored at one or more storage modules. In various embodiments, the computer instructions can be implemented on a computer system similar or identical to computer system 200 (FIG. 2) and the one or more processing modules and/or the one or more storage modules can be similar or identical to the processing modules and/or storage modules described above with respect to computer system 200. In some embodiments, the one or more processing modules can comprise one processing module and/or the one or more storage modules can comprise one storage module.

Referring to FIG. 8, in some embodiments, method 800 can comprise procedure 801 of activating or deactivating a first circuit of the vehicle charging station to prevent electricity from being provided to an electrical connector of the vehicle charging station for at least a first part of a first timeframe. In some embodiments, the electrical connector of procedure 801 can be similar or identical to electrical connector 111 (FIG. 1) and/or electrical connector 116 (FIG. 1).

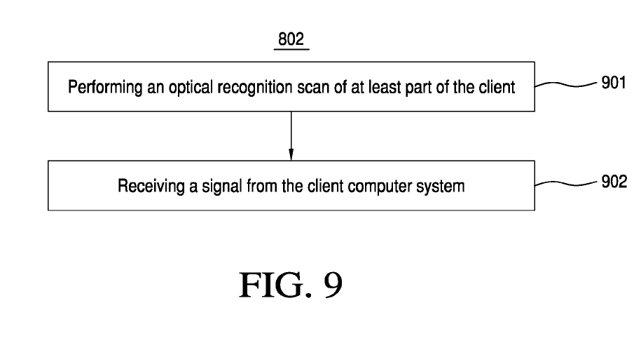

Referring to FIG. 8, in some embodiments, method 800 can comprise procedure 802 of authenticating an identity of a client of the vehicle charging station. In the same or different embodiments, this authentication of procedure 802 can be similar or identical to receiving the authentication described above with respect to system 100 (FIG. 1). In various embodiments, procedure 802 can be performed and/or can occur after procedure 801 is performed and/or occurs. In further embodiments, performing procedure 801 and procedure 802 can be similar or identical to performing procedure 403 (FIG. 4). In many embodiments, the client of procedure 802 comprises a user and/or a electric vehicle of the user. In the same or different embodiments, the client, the user, and/or the electric vehicle of procedure 802 can be similar or identical to client 104, user 105, and/or electric vehicle 101, respectively. For exemplary purposes, FIG. 9 illustrates procedure 802 according to an embodiment.

Referring to FIG. 9, procedure 802 can comprise process 901 of performing an optical recognition scan of at least part of the client. In the same or different embodiments, procedure 802 can comprise process 902 of receiving a signal from the client computer system. In many embodiments, the signal can identify the client.

Referring back to FIG. 8, in some embodiments, method 800 can comprise procedure 803 of deactivating or activating the circuit to provide the electricity to the electrical connector for a remaining part of the first timeframe. In various embodiments, procedure 803 can be performed and/or can occur after procedure 802 is performed and/or occurs. In various embodiments, performing procedure 803 can be similar or identical to performing procedure 404 and/or procedure 405.

Referring again to FIG. 8, in some embodiments, method 800 can comprise procedure 804 of activating or deactivating the circuit to prevent the electricity from being provided to the electrical connector either (a) before the first timeframe elapses if the electrical connecter is disconnected from an electric vehicle during the first timeframe, or (b) after the first timeframe elapses. In various embodiments, performing procedure 804 can be similar or identical to performing procedure 406.

Referring again to FIG. 8, in some embodiments, method 800 can comprise procedure 805 of receiving a reservation request from the client computer system at the charger computer system of the vehicle charging station and/or the centralized computer system. In some embodiments, procedure 805 can be performed and/or can occur before procedure 801 is performed and/or occurs. In various embodiments, performing procedure 805 can be similar or identical to performing procedure 401.

Referring to FIG. 8, in some embodiments, method 800 can comprise procedure 806 of calculating the first timeframe at the one or more processor modules of the charger computer system and/or the centralized computer system. In various embodiments, performing procedure 806 can be similar or identical to performing procedure 402.

In many embodiments, one or more of procedures 801-806 can be repeated for the first circuit and/or for one or more circuits of one or more other vehicle charging stations.

In various embodiments, any of system 100 (FIG. 1), method 400 (FIG. 4), or method 800 (FIG. 8) could be implemented at one or more of a conventional gas station, an establishment for short-term lodging (e.g., motel, hotel, etc.), group housing (e.g., apartments, condos, etc.), and a business (e.g., for employees, for fleet applications).

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that procedures 401-410 of FIG. 4, processes 501-504 of FIG. 5, processes 601-603 of FIG. 6, processes 701-703 of FIG. 7, procedures 801-806 of FIG. 8, and processes 901-902 of FIG. 9 may be comprised of many different procedures, processes, and activities and be performed by many different modules, in many different orders, that any element of FIGS. 1-9 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1) A method for coordinating a reservation for an electric vehicle charging station, the method being implemented via execution of computer instructions configured to run at one or more processing modules of at least one of a charger computer system or a centralized computer system and configured to be stored at one or more non-transitory memory storage modules of the at least one of the charger computer system or the centralized computer system, the method comprising:
executing one or more first computer instructions configured to receive from a client computer system of a client a request for a reservation for the electric vehicle charging station;
executing one or more second computer instructions configured to define a first timeframe for the reservation based on the request; and
if the electric vehicle charging station is available for use to charge a rechargeable energy storage system of an electric vehicle of the client for the first timeframe, executing one or more third computer instructions configured to prevent the electric vehicle charging station from making available electricity for at least a first part of the first timeframe until receiving an authentication of the client.

2) The method of claim 1 wherein:
the first timeframe and the at least the first part of the first timeframe begin simultaneously with each other.

3) The method of claim 1 wherein:
executing the one or more first computer instructions comprises executing one or more fourth computer instructions configured to receive at the at least one of the charger computer system or the centralized computer system at least one of:
a desired time that the client provides to the client computer system;
a charge level of the rechargeable energy storage system of the electric vehicle;
a location of the electric vehicle;
a planned route of the electric vehicle;
a location of the electric vehicle charging station; or
an estimated time of arrival of the electric vehicle at the electric vehicle charging station.

4) The method of claim 1 further comprising:
executing one or more fourth computer instructions configured to receive the authentication of the client; and
after executing the one or more fourth computer instructions, executing one or more fifth computer instructions configured to enable the electric vehicle charging station to make available the electricity.

5) The method of claim 4 further comprising:
after executing the one or more fifth computer instructions, executing one or more sixth computer instructions configured to provide the electricity to the rechargeable energy storage system of the electric vehicle for a remaining part of the first timeframe.

6) The method of claim 4 wherein:
executing the one or more fourth computer instructions comprises executing one or more sixth computer instructions configured to receive a signal from one of the client or the client computer system, the signal being configured to identify the client.

7) The method of claim 6 wherein:
executing the one or more sixth computer instructions comprises executing one or more seventh computer instructions configured to receive at least one of:
a sonic signal;
an infrared signal;
a radio frequency identification signal;
a Bluetooth signal;
a wireless modem signal;
a signal of a cable coupled between the charger computer system of the vehicle charging station and the electric vehicle; or
an optical recognition signal of an optical recognition device configured to recognize the client.

8) The method of claim 4 further comprising:
after executing the one or more fifth computer instructions and when or after the first timeframe elapses, executing one or more sixth computer instructions configured to prevent the electric vehicle charging station from making available the electricity for a period of time.

9) The method of claim 1 further comprising at least one of:
if the electric vehicle charging station is available for use to charge the rechargeable energy storage system of the electric vehicle for the first timeframe, executing one or more fourth computer instructions configured to inform the client that the request for the reservation is approved; or
if the electric vehicle charging station is unavailable for use to charge the rechargeable energy storage system of the electric vehicle for the first timeframe, executing one or more fifth computer instructions configured to inform the client that the request for the reservation is not approved.

10) The method of claim 1 further comprising:
executing one or more fourth computer instructions configured to provide at least one suggested alternative timeframe to the client.

11) A method for coordinating a reservation for an electric vehicle charging station, the method being implemented via execution of computer instructions configured to run at one or more processing modules of a client computer system of a client and configured to be stored at one or more non-transitory memory storage modules of the client computer system, the method comprising:
executing one or more first computer instructions configured to provide to at least one of a charger computer system or a centralized computer system a request for a reservation for the electric vehicle charging station; and
executing one or more second computer instructions configured to receive a confirmation regarding whether or not the request for the reservation is approved.

12) The method of claim 11 further comprising:
executing one or more third computer instructions configured to provide an authentication of the client to the at least one of the charger computer system or the centralized computer system.

13) A system for coordinating a reservation for an electric vehicle charging station, the system comprising:
at least one of a charger computer system or a centralized computer system;
wherein:
the at least one of the charger computer system or the centralized computer system is configured to communicate with a client computer system of a client;
the at least one of the charger computer system or the centralized computer system is configured to receive from the client computer system a request for a reservation for the electric vehicle charging station;
the at least one of the charger computer system or the centralized computer system is configured to define a first timeframe for the reservation based on the request; and
the at least one of the charger computer system or the centralized computer system is configured such that if the electric vehicle charging station is available for use to charge a rechargeable energy storage system of an electric vehicle for the first timeframe, the at least one of the charger computer system or the centralized computer system prevents the electric vehicle charging station from making available electricity for at least a first part of the first timeframe until an authentication of the client is received.

14) The system of claim 13 further comprising:
the electric vehicle charging system.

15) The system of claim 13 wherein:
the first timeframe and the at least the first part of the first timeframe begin simultaneously with each other.

16) The system of claim 13 wherein:
the at least one of the charger computer system or the centralized computer system is configured to receive the authentication from at least one of the client or the client computer system.

17) The system of claim 13 wherein:
the at least one of the charger computer system or the centralized computer system is configured to receive the authentication as a signal comprising at least one of:
a sonic signal;
an infrared signal;
a radio frequency identification signal;
a Bluetooth signal;
a wireless modem signal;
a signal of a cable coupled between the charger computer system of the vehicle charging station and the electric vehicle; or
an optical recognition signal of an optical recognition device configured to recognize the client.

18) The system of claim 13 wherein:
the client comprises one of a non-member user or a member user.

19) The system of claim 13 further comprising:
a return module configured such that:
if the electric vehicle charging station is available for use to charge the rechargeable energy storage system of the electric vehicle for the first timeframe, the return module informs the client that the request for the reservation is approved; or
if the electric vehicle charging station is unavailable for use to charge the rechargeable energy storage system of the electric vehicle for the first timeframe, the return module informs the client that the request for the reservation is not approved.

20) The system of claim 13 wherein:
the request for the reservation for the electric vehicle charging station comprises at least one of:
a desired time that the client provides to the client computer system;
a charge level of the rechargeable energy storage system of the electric vehicle;
a location of the electric vehicle;
a planned route of the electric vehicle;
a location of the electric vehicle charging station; or
an estimated time of arrival of the electric vehicle at the electric vehicle charging station.
